(19) United States
(12) Patent Application Publication
(10) Pub. No.: US 2007/0269316 A1
(43) Pub. Date: Nov. 22, 2007

(54) TURBINE BLADE WITH TRAILING EDGE CUTBACK AND METHOD OF MAKING SAME

(76) Inventors: Andrew D. Williams, Perth (GB); Gregory M. Nadvit, Hampden, MA (US); Michel P. Arnal, Turgi (CH)

Correspondence Address: BAKER BOTTS, LLP, 910 LOUISIANA, HOUSTON, TX, 77002-4995, US

(21) Appl. No.: 11/383,986

(22) Filed: May 18, 2006

(51) Int. Cl. B64C 27/46

(52) U.S. Cl. 416/223 R

(57) ABSTRACT

A turbine blade with a compound trailing edge cutback and method of making same is provided to remove cracks which have formed at a trailing edge cooling hole proximate the blade platform. The compound cutback is made along the entire trailing edge of the blade. The compound cutback has three sections. The first section is generally arc-shaped and is formed where the trailing edge of the blade blends into the platform. The second section is linear having a non-zero slope and extends from the root to an intermediate span of the blade. The third section is also linear having an approximately zero slope and extends from the intermediate span of the blade to the tip.

### FIELD OF THE INVENTION

The present invention relates generally to techniques for repairing gas turbine rotor blades having cracks in their trailing edges and more specifically to a turbine blade having a trailing edge cutback and a method of making same.

### BACKGROUND

The turbine section of gas turbine engines typically comprise multiple sets or stages of stationary blades, known as nozzles or vanes, and moving blades, known as rotor blades or buckets. FIG. 1 illustrates a typical rotor blade 100 found in the first stage of the turbine section, which is the section immediately adjacent the combustion section of the gas turbine and thus is in the region of the turbine section that is exposed to the highest temperatures. A known problem with such blades 100 is premature cracking 104. As shown in FIG. 1, the cracking 104 typically commences at a root trailing edge cooling hole 110a located on a trailing edge 112 of an airfoil 102 of the blade 100 adjacent the platform 108. This root trailing edge cooling hole 110a is particularly vulnerable to thermal mechanical fatigue (TMF) because of excessive localized stress that occurs during start-stop cycles and creep damage that occurs under moderate operating temperatures, i.e., during periods of base load operation. Because the root trailing edge cooling hole 110a is affected by both mechanisms, premature cracking 104 has been reported within the first hot gas path inspection cycle. If the cracking 104 is severe enough, it can force early retirement of the blade 100. In order to prevent this early retirement, various approaches can be effective, either singly or in combination.

The principal damage at the root trailing edge cooling hole 110a is a consequence of the combination of mechanical stress due to centrifugal load and thermal stress that results from the significant temperature gradient present at the root trailing edge cooling hole 110a. The initial damage is generally relatively confined, i.e., the cracking 104 appears localized. This suggests that the blade 100 might be salvaged if the confined damage is removed. In order to restore the structural integrity of the blade 100 however, it is desirable to remove all of the original cracking 104. In other words, any removal of material from the trailing edge 112 should be of sufficient depth to eliminate the cracking 104. However, it is undesirable to remove too much material as this can reduce the strength of the blade 100 to the degree that new cracking 104 might form even more quickly.

### SUMMARY

In one embodiment of the present invention, a turbine blade having a trailing edge cutback along its entire length is provided. The cutback has a compound shape. More specifically, the cutback is defined by three distinct sections. The first section is arc-shaped and is formed in the root of the airfoil. The second section is linear and extends from the root to an intermediate span of the blade, which may be the approximate mid-span of the blade. The third section is linear and extends from the intermediate span of the blade to the tip of the blade. The slope of the second linear section is different from the slope of the third linear section. The slope of the second section is generally non-zero while the slope of the third linear section is approximately zero.

In another embodiment of the present invention, a method of removing a crack in a root portion of a trailing edge of a turbine blade is provided. The method includes the step of cutting back the trailing edge along its entire length. The cutting back step includes forming a first section of a cutback proximate a root portion of the trailing edge. This first section of the cutback may be arc-shaped. The cutting step also includes forming a second section of a cutback between the root portion of the trailing edge and an intermediate span of the trailing edge. The second section of the cutback may be linear having a non-zero slope. The cutting back step further includes forming a third section of a cutback between the intermediate span of the trailing edge and a tip portion of the trailing edge. The third section of the cutback may be linear having a substantially zero slope.

### BRIEF DESCRIPTION OF THE DRAWINGS

The following drawings form part of the present specification and are included to further demonstrate certain aspects of the present invention. The present invention may be better understood by reference to one or more of these drawings in combination with the description of embodiments presented herein. However, the present invention is not intended to be limited by the drawings.

FIG. 1 is a perspective view of a prior art rotor blade.

FIG. 2 is a perspective view showing a rotor blade having a compound cutback in accordance with the present invention.

FIG. 3 is a side view of the rotor blade illustrated in FIG. 2.

FIG. 4 is an enlarged view of the compound cutback in accordance with the present invention.

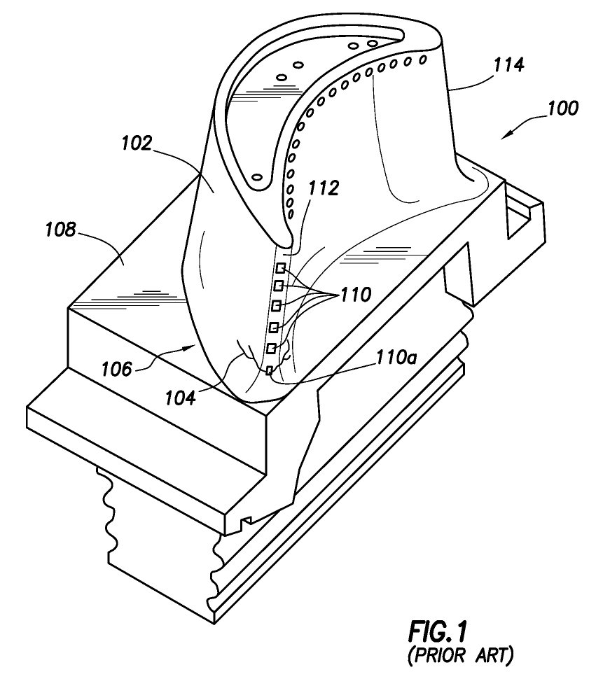

### DETAILED DESCRIPTION

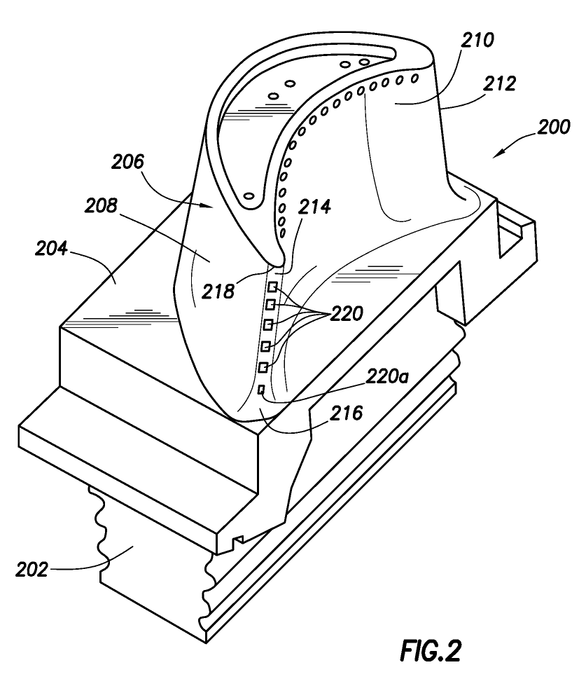

The present invention will now be described with reference to the following exemplary embodiments. Referring now to FIG. 2, a turbine blade in accordance with the present invention is shown generally by reference number 200. The turbine blade 200 has three primary sections a shank 202 which is designed to slide into a disc on the shaft of the rotor (not shown), a platform 204 connected to the shank 202 and an airfoil 206 connected to the platform. Generally, during the blade 200's initial manufacture, the shank 202, platform 204 and airfoil 206 are all cast as a single part.

The airfoil 206 is defined by a concave side wall 208, a convex side wall 210, a leading edge 212 and opposite trailing edge 214; the leading and trailing edges being the two areas where the concave side wall and convex side wall meet. The airfoil 206 has a root 216 which is proximate the platform 204 and a tip 218 which is distal from the platform. As with prior art turbine blades, air is supplied to the inside cavity of the airfoil 206 (not shown) from the compressor to cool the inside of the airfoil. The cooling air exits a plurality of cooling holes 220, at least some of which are formed in the trailing edge 214. The cooling hole at the trailing edge nearest the root of the blade 220a is the one where the cracking 104 typically takes place. These cracks must be removed to prevent their future propagation.

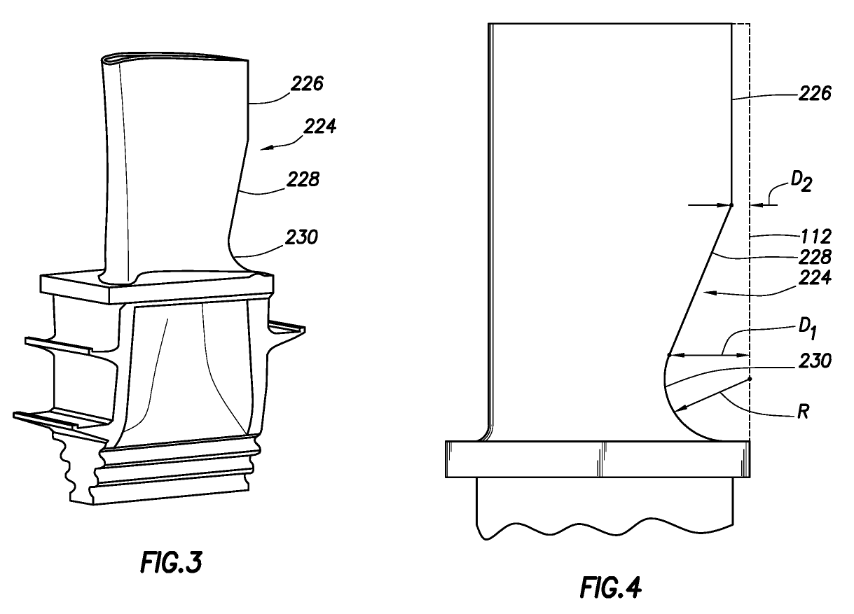

The method in accordance with the present invention involves removing the cracks by forming a trailing edge cutback 224 which extends along the entire length of the trailing edge 214, i.e., from the root 216 of the blade to the tip 218. As best seen in FIG. 4, in one exemplary embodiment, the cutback 224 has three discrete sections 226, 228 and 230. As those of ordinary skill in the art will appreciate, the cutback 224 may have other suitable shapes, which enable the crack to be removed without significantly compromising the aerodynamic properties of the blade.

The first section 226 of the cutback 224 is arc-shaped and formed at the root of the trailing edge 214 where it is formed with the platform 204. As those of ordinary skill in the art will appreciate, the depth of the cut of the first section 226 and thus the radius R of the arc will be dependent on the depth of the cracks 104. In one exemplary embodiment, the radius is approximately 10 mm (0.394″).

The second section 228 of the cutback 224 is linear and has a generally non-zero slope. The second section 228 extends from the root to an intermediate span of the blade, which may be the approximate mid-span of the blade. Again, the depth of the cut which forms the second section 228 will be dependent upon the depth of the cracks 104. In one exemplary embodiment, the depth (D₁) of the second section 228 of the cutback 224 is approximately 15 mm (0.59″) in the root region and the depth (D₂) at the intermediate span is approximately 2 mm (0.079″).

The third section 230 of the cutback 224 is also linear and has a generally zero slope. The third section 230 extends from the intermediate span of the blade to the tip 218. In one exemplary embodiment, the depth (D₂) of the third section 230 of the cutback 224 is approximately 2 mm (0.079″) along its entire length, i.e., it has a uniform depth.

With the dimensions of the exemplary embodiment, the temperature distributions of the repaired blade 200 are comparable to those of the unrepaired blade 100. While the root trailing edge cooling hole 220a is still most susceptible to TMF and creep damage, the maximum principal stress associated with the repair only increases about 10%. The corresponding TMF life would probably be reduced approximately 65%, relative to the TMF life of the original design without the compound cutback 224. The increase of stress is tolerable considering the maximum depth of the cutback 224 near the root region 216.

If all traces of original cracking 104 are absent from the root trailing edge cooling hole 220a, it should result in the restoration of a useful period of service life to the blade 200. It is likely that the compound cutback 224 will be more effective when the blade 200 operates on frequently cycled machines where the contribution of creep damage is less predominant than would be expected for base load machines.

The method of forming the cutback 224 will now be described. The cutback 224 may be formed by scribing a line and blending back to the scribed line. A non-destructive test may then be performed.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. A turbine blade, comprising a trailing edge having a cutback which extends along its entire length.

2. The turbine blade according to claim 1, wherein the cutback has a compound shape.

3. The turbine blade according to claim 2, wherein the cutback comprises a first arc-shaped section formed in a root of the airfoil, a second linear section which extends from the root to an intermediate span of the blade, and a third linear section which extends from the intermediate span of the blade to a tip of the blade, wherein the slope of the second linear section is different from the slope of the third linear section.

4. The turbine blade according to claim 3, wherein the intermediate span of the blade is at the approximate mid-span of the blade.

5. The turbine blade according to claim 3, wherein the first arc-shaped section has a radius of approximately 10 mm.

6. The turbine blade according to claim 3, wherein the slope of the third linear section is approximately zero.

7. The turbine blade according to claim 3, wherein the second linear section is cutback approximately 15 mm proximate the root and approximately 2 mm at the approximate mid-span.

8. The turbine blade according to claim 6, wherein the third linear section is cutback substantially uniformly 2 mm between approximate mid-span and the tip of the blade.

9. A turbine blade, comprising
a platform, and
an airfoil connected to the platform, the airfoil extending from a root proximate the platform to a tip distal to the platform and having a concave side and a convex side, the concave side and convex side joining at a leading edge and a trailing edge,
wherein the trailing edge has a cutback which extends along the entire length of the trailing edge.

10. The turbine blade according to claim 9, wherein the cutback has a compound shape.

11. The turbine blade according to claim 10, wherein the cutback comprises a first arc-shaped section formed in the root of the airfoil, a second linear section which extends from the root to an intermediate span of the blade, and a third linear section which extends from the intermediate span of the blade to the tip of the blade, wherein the slope of the second linear section is different from the slope of the third linear section.

12. The turbine blade according to claim 11, wherein the intermediate span of the blade is at the approximate mid-span of the blade.

13. The turbine blade according to claim 11, wherein the first arc-shaped section has a radius of approximately 10 mm.

14. The turbine blade according to claim 11, wherein the second linear section is cutback approximately 15 mm proximate the root and approximately 2 mm at the approximate mid-span.

15. The turbine blade according to claim 11, wherein the slope of the third linear section is approximately zero.

16. The turbine blade according to claim 15, wherein the third linear section is cutback substantially uniformly 2 mm between approximate mid-span and the tip of the blade.

17. A method of removing a crack formed in a trailing edge of a turbine blade, the method comprising the steps of:
forming a first section of a cutback proximate a root of the trailing edge;
forming a second section of a cutback between the root of the trailing edge and an intermediate span of the trailing edge; and
forming a third section of a cutback between the intermediate span of the trailing edge and a tip of the trailing edge.

18. The method according to claim 17, wherein the step of forming the first section of the cutback includes forming an arc-shaped cutback.

19. The method according to claim 18, wherein the arc-shaped cutback has a radius of approximately 10 mm.

20. The method according to claim 17, wherein the step of forming the second section of the cutback includes forming a linear cutback having a non-zero slope.

21. The method according to claim 20, wherein the depth of the linear cutback of the second section is approximately 15 mm at the root of the trailing edge and approximately 2 mm at the intermediate span of the trailing edge.

22. The method according to claim 17, wherein the step of forming the third section of the cutback includes forming a linear cutback having a substantially zero slope.

23. The method according to claim 22, wherein the depth of the linear cutback of the third section is approximately 2 mm.

24. A method of removing a crack in a root of a trailing edge of a turbine blade, comprising the step of cutting back the trailing edge along its entire length.

25. The method according to claim 24, wherein the cutting back step comprises:
forming a first section of a cutback at the root of the trailing edge;
forming a second section of a cutback between the root of the trailing edge and an intermediate span of the trailing edge; and
forming a third section of a cutback between the intermediate span of the trailing edge and a tip of the trailing edge.

26. The method according to claim 25, wherein the step of forming the first section of the cutback includes forming an arc-shaped cutback.

27. The method according to claim 25, wherein the step of forming the second section of the cutback includes forming a linear cutback having a non-zero slope.

28. The method according to claim 25, wherein the step of forming the third section of the cutback includes forming a linear cutback having a substantially zero slope.
